(19) United States
(12) Patent Application Publication
(10) Pub. No.: US 2025/0140001 A1
(43) Pub. Date: May 1, 2025

(54) BAKERY TRAY VALIDATION SYSTEM

(71) Applicant: Rehrig Pacific Company, Los Angeles, CA (US)

(72) Inventors: Daniel James Thyer, Dallas, TX (US); Peter Douglas Jackson, Alpharetta, GA (US); Robert Lee Martin, JR., Dallas, TX (US); Justin Michael Brown, Coppell, TX (US)

(21) Appl. No.: 18/931,938

(22) Filed: Oct. 30, 2024

Related U.S. Application Data
(60) Provisional application No. 63/594,887, filed on Oct. 31, 2023.

(51) Int. Cl. G06V 20/68; G06Q 50/12; G06V 10/75

(52) U.S. Cl. CPC G06V 20/68; G06Q 50/12; G06V 10/751; G06V 2201/07

(57) ABSTRACT

A computer system for validating trays loaded with products receives at least one image of products in at least one tray of a plurality of trays in an imaging area. A type of the products in the at least one tray is determined based upon the at least one image. The type of products in the at least one tray is compared to at least one order. A confirmation or error is indicated based upon the comparison. In some examples, the products are bakery products of different types loaded in plastic, stackable bakery trays. In one example method, a plurality of stacks of loaded bakery trays are imaged from a front or rear of the trays. In another example method, the plurality of stacks are imaged from overhead as the trays are loaded onto the stacks.

### BACKGROUND

In some distribution centers, many different types of bakery products, such as different types of buns (hot dog buns, hamburger buns, triple hamburger buns, etc), bread, muffins, etc, arrive in bakery trays. Bakery trays arrive stacked on dollies. Each dolly has a base and casters supporting the base. Each bakery tray contains bakery products of only one type.

At the distribution center, orders are fulfilled for each of a plurality of stores (e.g. restaurants, grocery stores, etc). An order may specify a certain quantity of each of a plurality of different types of bakery products. Generally, the orders will be fulfilled in increments of complete stacks of a single bakery product type when possible; however, when necessary, one or more dollies will be restacked with a mixture of different types of bakery products.

### SUMMARY

A computer system for validating trays loaded with products receives at least one image of products in at least one tray of a plurality of trays in an imaging area. A type of the products in the at least one tray is determined based upon the at least one image. The type of products in the at least one tray is compared to at least one order. A confirmation or error is indicated to the worker based upon the comparison.

In some examples, the products are bakery products of different types loaded in plastic, stackable bakery trays. In one example method, a plurality of stacks of loaded bakery trays are imaged from a front or rear of the trays. In another example method, the plurality of stacks are imaged from overhead as the trays are loaded onto the stacks.

### BRIEF DESCRIPTION OF THE DRAWINGS

FIG. 1 is a top, schematic view of a bakery tray validation system according to one embodiment.

FIG. 2 is a side view of the imaging area of the bakery tray validation system of FIG. 1.

FIG. 3 shows front or rear views of three example bakery trays loaded with bakery products of three different types that can be validated using the system of FIG. 1.

FIG. 4 is a front view of the plurality of stacks of bakery trays of FIG. 2.

FIG. 5 is a rear view of the plurality of stacks of bakery trays of FIG. 2.

FIG. 6 is a top, schematic view of a bakery tray validation system according to another embodiment.

FIG. 7 is a front view of the imaging area of FIG. 6 with a first bakery tray loaded thereon.

FIG. 8 is a front view of the imaging area of FIG. 6 with a second bakery tray loaded thereon.

FIG. 9 is a front view of the imaging area of FIG. 6 with a plurality of complete stacks of bakery trays loaded thereon.

FIG. 10 is a flowchart of one example method for operating the validation system of FIG. 6.

FIG. 11 is a flowchart of another example method for operating the validation system of FIG. 6.

FIG. 12 is a side view of a bakery tray validation system according to another embodiment.

### DETAILED DESCRIPTION

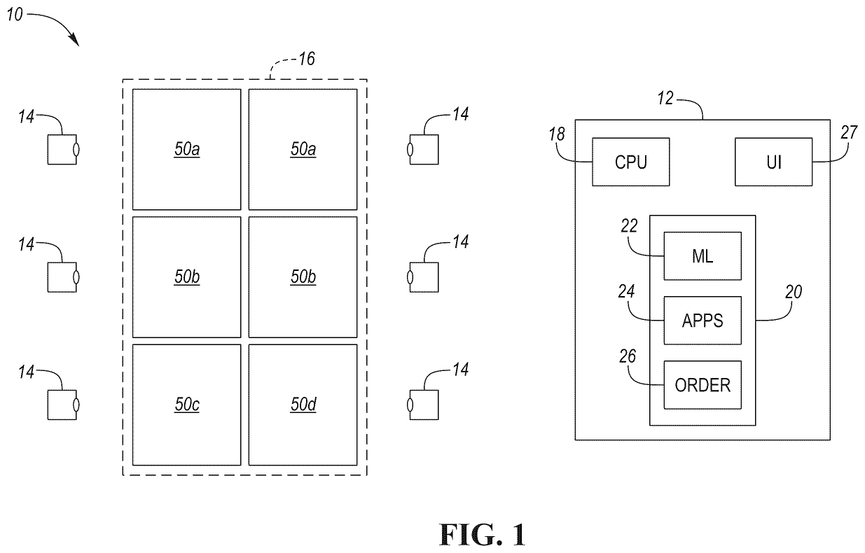

FIG. 1 is a top, schematic view of a bakery tray validation system 10. The bakery tray validation system 10 ensures that the right number of trays containing the right bakery products are delivered to fulfill an order from each store. The bakery tray validation system 10 generally includes at least one computer 12 and a plurality of cameras 14 (or at least one camera) directed toward an imaging area 16, upon which a plurality of first stacks 50a, a plurality of second stacks 50b, and third stack 50c, and a fourth stack 50d of bakery trays can be received. The plurality of cameras 14 may be visible-light electronic digital imaging devices.

The at least one computer 12 includes at least one processor 18 and at least one non-transitory computer-readable storage medium, or storage 20, such as electronic memory, electronic storage, magnetic storage, cloud storage, or some combination thereof. The storage 20 stores at least one machine learning model 22 and at least one application 24 having instructions which when executed by the at least one processor 18 cause the bakery tray validation system 10 to perform the functions described herein.

The storage 20 also stores a plurality of orders 26, each received from a different one of a plurality of stores. Each order 26 specifies a certain quantity of each of a plurality of different types of bakery products (e.g. quantities of bakery trays of each type of bakery product). The at least one computer 12 further includes a user interface 27, including one or more of a keyboard, display, touchscreen, microphone, speaker, etc. The at least one computer 12 is connected via wires or wireless connections (e.g. wireless network) to the plurality of cameras 14.

The at least one machine learning model 22 is trained with a plurality of images of loaded bakery trays with different types of bakery products in the bakery trays. In one example, each image is labeled manually with its associated type of bakery product. The bakery products available in the distribution center (and trained in the at least one machine learning model 22) may include two or more of: hot dog buns, hamburger buns, triple hamburger buns, bread, muffins, English muffins, or other bakery products. Virtual images of bakery products in trays (or without the trays) may be created and artificially modified to simulate different lighting conditions, glare, shadows, etc. The virtual images are labeled and can be used to train the at least one machine learning model 22.

Each type of bakery product available in the bakery trays in the distribution center is consistently associated with one or more of: different packaging (optionally with different indicia thereon), different stack heights of the bakery trays, different appearance of the bakery products themselves, and different appearance of the bakery trays. In one example, a plurality of training images with the applicable differentiating characteristics may be manually labeled as to the type of bakery products in each tray in each image. Each bakery tray includes a plurality of packages, but all of the packages in each tray contain the same type of bakery product.

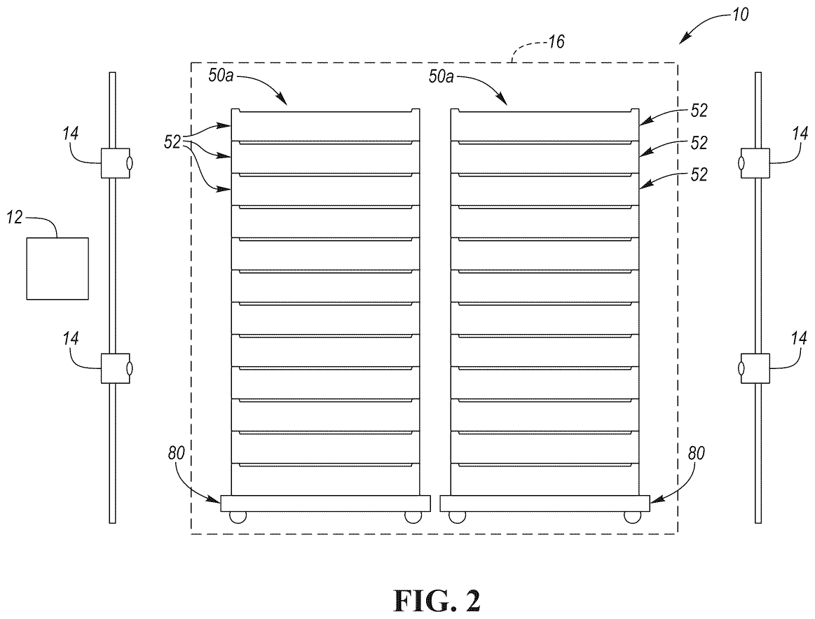

FIG. 2 is a side view of the imaging area 16 of the bakery tray validation system 10 of FIG. 1. Two of the first stacks 50a are shown in FIG. 2 between the plurality of cameras 14. Each of the plurality of first stacks 50a includes a plurality of bakery trays 52 stacked upon one another and on a dolly 80. The dolly 80 includes a base supporting the bakery trays 52 and a plurality of casters (or wheels) supporting the base.

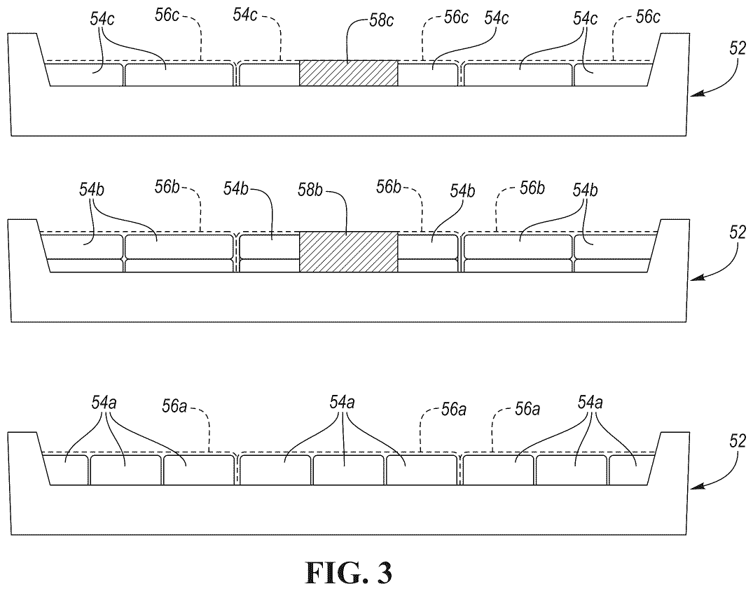

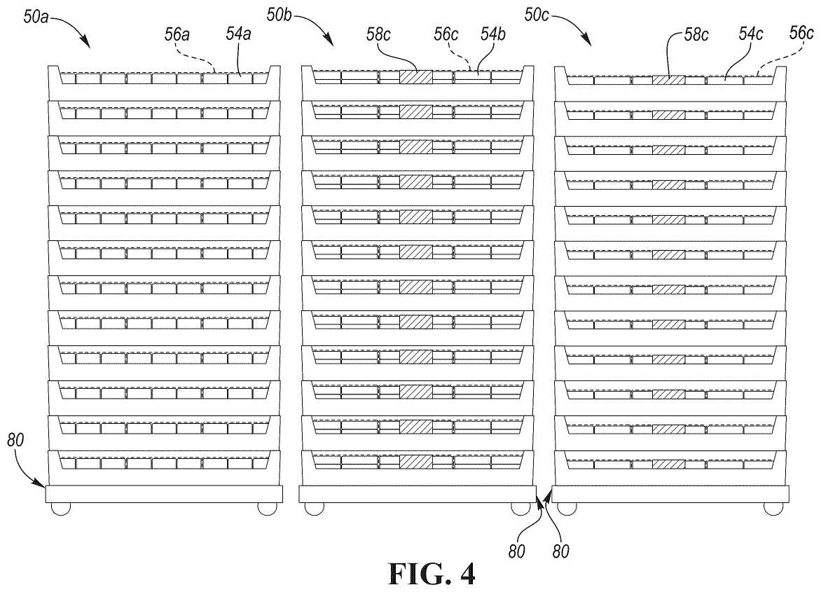

Again, FIG. 2 is a side view of the bakery trays 52 from which the contents may be almost completely obscured (depending upon the structure of the bakery tray 52). FIG. 3 shows a front (or rear) views of three bakery trays 52, each from one of the three stacks 50 of FIGS. 1 and 4, i.e. a first stack 50a, a second stack 50b, and a third stack 50c. Referring to FIGS. 2 and 3, in this example, each bakery tray 52 includes a base having side edges and front and rear edges. Side walls extend upward from the side edges of the base. Front and rear walls extend upward from front and rear edges of the base. At least one, and in this example both, of the front and rear walls are significantly shorter than the side walls, such that products 54 within the bakery tray 52 are partially visible from the from and rear of the bakery tray 52. In other words, the bakery trays 52 have “dropped” front and rear walls that only partially obscure the bakery products 54 from the front or rear view. Loaded bakery trays 52 can be stacked on one another as shown in FIG. 2, with each bakery tray 52 supported on the side walls of the bakery tray 52 below. As is typical, the bakery trays 52 in this example are each integrally molded as a single piece of plastic.

Referring to FIG. 3, the lower bakery tray 52 includes a plurality of first bakery products 54a in each of a plurality of first packages 56a (such as plastic bags). In this example, the plurality of first packages 56a do not have indicia. The plurality of first packages 56a in this example are substantially transparent with no indicia. Alternatively, the plurality of first packages 56a could be a solid color with no indicia.

Also referring to FIG. 3, the middle bakery tray 52 includes a plurality of second bakery products 54b in each of a plurality of second packages 56b (such as plastic bags). In this example, the plurality of second packages 56b each have a second indicia 58b (only one visible because of orientations, or alternatively only one of the plurality of second packages 56b has the second indicia 58b).

Again referring to FIG. 3, the upper bakery tray 52 includes a plurality of third bakery products 54c in each of a plurality of third packages 56c (such as plastic bags). In this example, the plurality of third packages 56c each have a third indicia 58c (only one visible because of orientations, or alternatively only one of the plurality of third packages 56c has the third indicia 58c).

The second indicia 58b may be a second color, which is different from a color of the third indicia 58c. The indicia 58b, 58c may be a solid stripe or block. The plurality of first packages 56a in this example have an absence of the indicia.

Although the packages 56 in this example are plastic bags, the packages 56 could alternatively be boxes, paper bags, wrapping of plastic or paper, or other suitable packages.

In each of the bakery trays 52 in FIG. 3, the bakery products 54 are partially obscured by the wall (the front wall or rear wall, or the dropped wall) of the tray. The at least one machine learning model would be trained with images similar to the three images of FIG. 3. The training images could be labeled manually with respect to the type of bakery product in each. Virtual images of products in bakery trays 52 could be created with a computer and used to train the at least one machine learning model 22.

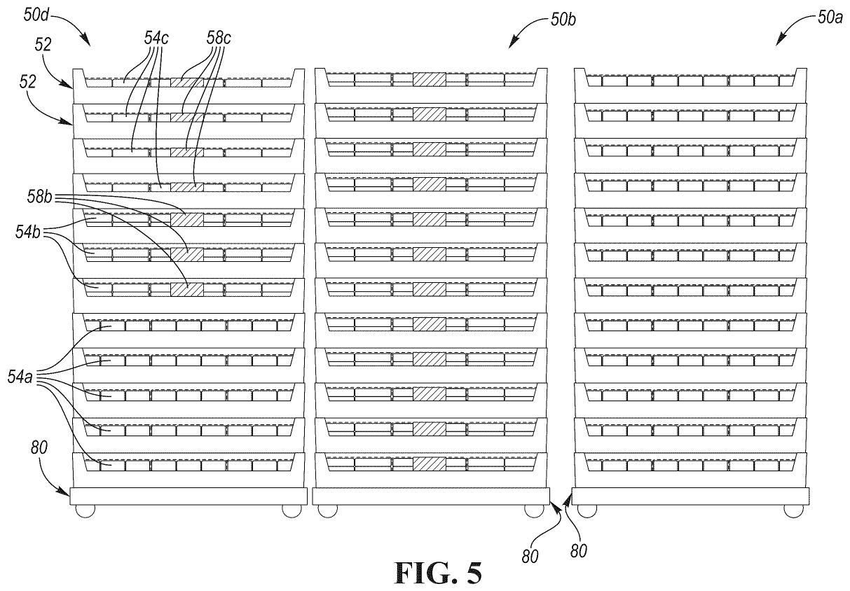

Referring to FIGS. 4 and 5, from the front or rear, the plurality of first bakery products 54a, plurality of second bakery products 54b, plurality of third bakery products 54c and their associated packaging and indicia (if present) are visible through the drop wall of the bakery tray 52, even when stacked.

Referring to FIGS. 1, 4 and 5, the plurality of first stacks 50a contain only bakery trays 52 with the plurality of first bakery products 54a, the plurality of second stacks 50b contain only bakery trays 52 with the plurality of second bakery products 54b, and the third stack 50c contains only bakery trays 52 with the plurality of third bakery products 54c. The fourth stack 50d contains a mixture of bakery trays 52 with the plurality of first bakery products 54a, bakery trays 52 with the plurality of second bakery products 54b and bakery trays 52 with plurality of third bakery products 54c.

Referring to FIGS. 4 and 5, the plurality of cameras 14 would image the front and rear of the plurality of stacks 50 in the imaging area 16. Among the plurality of cameras 14, at least one image of each of the plurality of stacks 50 is obtained, sent to, and received by the at least one computer 12. In this example, at least one image of the front or rear of each of the bakery trays 52 is obtained by the plurality of cameras 14 and sent to the at least one computer 12. If there is lens distortion in the image, such as keystone distortion (especially if only one camera 14 is used on each side, or the uppermost camera 14 on each side), the at least one computer 12 corrects the image by removing the distortion (such techniques are well-known). This makes all of the trays 52 in the image the same size (or substantially so). This makes training the at least one machine learning model 22 easier because they can be trained with higher accuracy with fewer images.

The at least one computer 12 separates the images from the plurality of cameras 14 into one image of each of the bakery trays 52. Each of these images is analyzed by the at least one computer 12 using the at least one machine learning model 22. A bakery product type is inferred by the at least one computer 12 using the at least one machine learning model 22 based upon each of the images. The different packaging, with different indicia thereon, or the absence thereof, different stack heights of the bakery trays, and different appearance of the bakery products themselves may factor into the inference of the bakery product types. The type of bakery product in each of the bakery trays 52 is identified by the at least one computer 12. The at least one computer 12 then compares the quantity of bakery trays 52 of each type with the quantities indicated in the order 26 (the order 26 for which this group of stacks of bakery trays 52 has been assembled) and indicates any errors or confirms that the order has been filled correctly.

In this example, the order 26 requires: twenty-nine bakery trays 52 of the plurality of first bakery products 54a, twenty-seven bakery trays 52 of the plurality of second bakery products 54b, and sixteen bakery trays 52 of the plurality of third bakery products 54c. Therefore, the at least one computer 12 would confirm that the order 26 has been filled correctly.

However, if the order 26 requires: thirty bakery trays 52 of the plurality of first bakery products 54a, twenty-six bakery trays 52 of the plurality of second bakery products 54b, and sixteen bakery trays 52 of the plurality of third bakery products 54c. Therefore, the at least one computer 12 would confirm that the dollies 80 have been loaded incorrectly and would indicate that there is one too many bakery trays 52 of the second bakery products 54b and that the dollies 80 are short one bakery tray 52 of the first bakery product 54a.

The imaging area 16 may contain stacks 50 of bakery trays 52 for more than one order 26. For example, one order 26 may require one of the first stacks 50a of the plurality of first bakery products 54a, the two second stacks 50b of the plurality of second bakery products 54b, and the third stack 50c of the plurality of third bakery products 54c. Another order 26 may require one of the first stacks 50a of the plurality of first bakery products 54a and the fourth stack 50d, which contains some bakery trays 52 of each of the first bakery products 54a, the second bakery products 54b, and the third bakery products 54c.

If an order 26 requires more bakery trays 52 than can be imaged at once in the imaging area 16, then the user can simply so indicate in the order 26 and then place another one or more stacks of bakery trays 52 in the imaging area 16. The process is then repeated and the quantities of the two (or more) groups of stacks are totaled and then compared to the order 26. The at least one computer 12 then indicates confirmation or indicates error (including which bakery product types and whether there are too many or too few).

In one example, the bakery trays 52 may all be identical, in which case the appearance of the bakery trays 52 does not help the at least one computer 12 distinguish the bakery product types.

In another example, at least one of the types of bakery products is exclusively placed in a bakery tray 52 with an appearance that differs in some way (structure, size, color, indicia) from bakery trays 52 containing bakery products of other types. In this example, the different appearances of the bakery trays 52 would assist the at least one computer 12 in distinguishing the type of bakery products in all of the bakery trays 52 (of either type).

In yet another example, for two different types of bakery products, identical bakery trays 52 may be stacked upon one another at different stacking heights (e.g. by varying the relative orientations of the bakery trays 52, as is well-known). For example, bakery trays containing a first type of bakery product may be stacked on one another at a first height, while identical bakery trays containing a second type of bakery product may be stacked on one another at a second height that is less than the first height. In this case, the different stacking heights may assist the at least one computer 12 (via the at least one machine learning model 22) to distinguish the two types of bakery products.

Of course, in a particular distribution center, all of these examples may occur simultaneously, i.e. there may be multiple different types of bakery products that are transported in the same type of bakery tray, while two other types of bakery products are transported in a second type of bakery tray, and while another type of bakery product is transported in the second bakery tray but at a different stacking height.

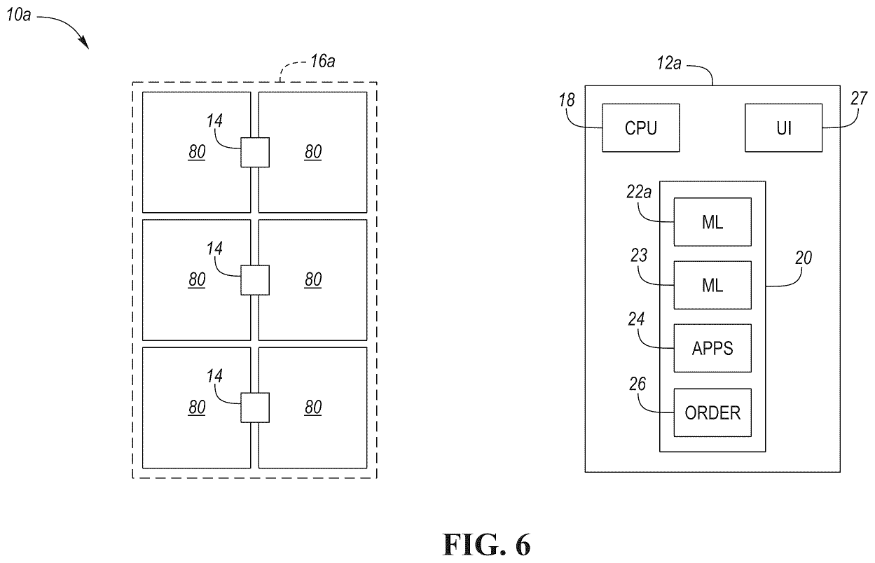

FIG. 6 is a top, schematic view of another embodiment of a bakery tray validation system 10a. The bakery tray validation system 10a includes at least one computer 12a that is identical to the at least one computer 12 of the previous embodiment, but stores instructions that when executed by the at least one processor 18 cause the bakery tray validation system 10a to perform the functions described here. Additionally, in this embodiment, the at least one machine learning model 22a is trained with labeled images that are top views of bakery trays 52 with a plurality of first bakery products 54a, bakery trays 52 with a plurality of second bakery products 54b, bakery trays 52 with a plurality of third bakery products 54c, and empty bakery trays 52. Alternatively, the at least one machine learning model 22a is trained with labeled images that are just top views of the various products 54a, b, c, i.e. without the bakery trays 52. In practice, the at least one machine learning model 22a would likely be trained with images of top views of more than three types of bakery products 54.

The storage 20 on the at least one computer 12a may also include at least one machine learning model 23 (mostly likely one such machine learning model) that is trained with labeled images that are top views of empty bakery trays 52 and variously-loaded bakery trays 52. This at least one machine learning model 23 is trained to detect the presence of any new bakery tray 52 (containing any product or empty) in an image.

In the bakery tray validation system 10a, the plurality of cameras 14 are arranged overhead above the imaging area 16a. The plurality of cameras 14 are oriented to look down onto the bakery trays 52 as they are being placed onto a dolly 80 or onto a stack. This would provide an expanded view of the first bakery product 54a, b, c in each bakery tray 52 as it was placed on the stack. The cameras 14 (or a single camera 14) take at least one image of the bakery products in each bakery tray 52 after each bakery tray 52 is placed on one of the stacks and before another bakery tray 52 is placed on that stack. The at least one computer 12 infers types of bakery products in each bakery tray 52 after each of the bakery trays 52 is placed on the stack. Alternatively, the at least one computer 12a may wait until the stack is completed before analyzing the accumulated images using the at least one machine learning model 22a. The at least one computer 12a then compares the quantities of inferred types of bakery products to the order 26 and generates a confirmation or an error as appropriate.

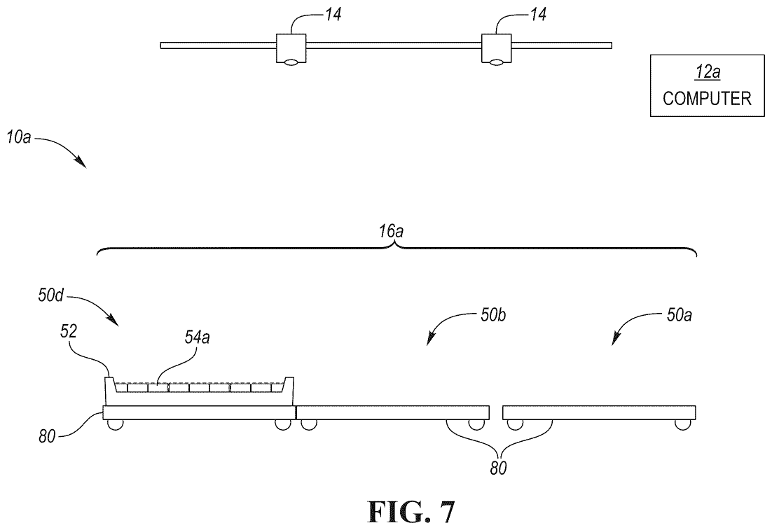

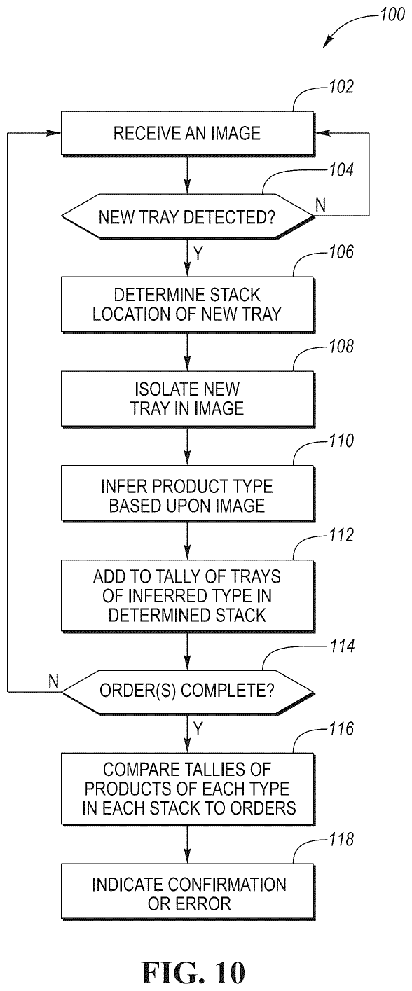

One example is demonstrated with respect to FIGS. 7 to 9 and the method 100 of FIG. 10. In FIGS. 6 and 7, the plurality of cameras 14 are mounted overhead above an imaging area 16a. Empty dollies 80 are moved into the imaging area 16a. A user will load the dollies 80 with bakery trays 52 each having bakery products therein in response to instructions (e.g. text or speech instructions or visual cues, such as indicators) from the at least one computer 12a, which generates the instructions based upon one or more orders 26. Again, each bakery tray 52 has either a plurality of first bakery products 54a, a plurality of second bakery products 54b, or a plurality of third bakery products 54c—or it may be empty. Again, in practice, more than three different types of bakery products may be used.

In FIG. 7, a plurality of stacks 50a, 50b, and 50d will be created based upon one or more orders 26 (FIG. 6), each stack on one of the plurality of dollies 80. In FIG. 7, the user has placed the first bakery tray 52 on one of the dollies 80 in response to instructions from the at least one computer 12a. The plurality of cameras 14 (or a single camera 14) may periodically image the imaging area 16a (e.g. every second or two) and transmit those images to the at least one computer 12a.

In step 102 (FIG. 10), the at least one computer 12a receives each image. If there is lens distortion in the image, such as keystone distortion (especially if only one camera 14 is used), the at least one computer 12a corrects the image by removing the distortion (such techniques are well-known). This makes all of the trays 52 in the image the same size (or substantially so). This makes training the at least one machine learning model 22a easier because they can be trained with higher accuracy with fewer images.

The at least one computer 12a analyzes each image to determine if a new bakery tray 52 has been placed in the imaging area 16a (e.g. on one of the dollies 80). If not, the next image is analyzed. The at least one computer 12a uses the at least one machine learning model 23 that is trained specifically for detecting whether there is a new bakery tray 52 in the image. The at least one computer 12a uses the tray-detecting machine learning model 23 to detect the presence of a new bakery tray 52 in the image in step 104. If no new bakery tray 52 is detected in the image by the at least one computer 12a, then the at least one computer 12a waits to receive the next image in step 102.

If a new bakery tray 52 is detected in step 104, then the at least one computer 12a determines which stack (e.g. which dolly 80) received the new bakery tray 52. In step 108, the image is cropped to include just the new bakery tray 52 and its contents (which could be empty) or just the contents, which in this example are a plurality of first bakery products 54a, i.e. crops out the rest of the imaging area 16a from the image.

In step 110, the at least one computer 12a infers one of the types of bakery products from the image using the at least one machine learning model 22a. In step 112, the at least one computer 12a increments the tally of bakery products of that type in that stack 50 (e.g. on that dolly 80).

The at least one computer 12a may also infer that the bakery tray 52 is empty. That could generate an immediate warning or alarm, or the at least one computer 12a may just tally the bakery tray 52 as an empty bakery tray 52 and not increment the tallies of the bakery products.

In step 114, the at least one computer 12a determines whether all of the dollies 80 have been loaded, e.g. the order 26 or orders 26 have been completed (or whether the loading process is otherwise terminated). In this example, it is not complete because only one bakery tray 52 has been loaded. Therefore, the at least one computer 12a returns to step 102 and receives the next image.

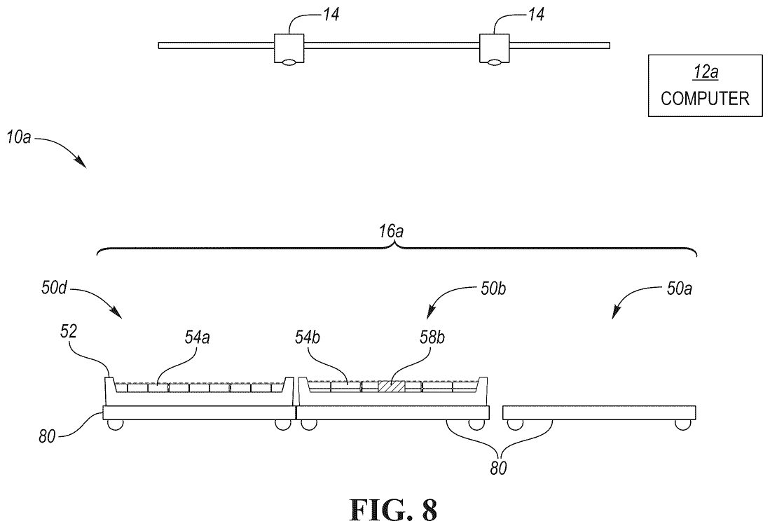

In FIG. 8, a second bakery tray 52 has been added by the worker, this time to a different dolly 80 and a different stack 50. Again, the at least one computer 12a detects the new tray in step 104 (using the tray detection machine learning model 23), determines the stack or dolly 80 to which the new bakery tray 52 has been added in step 106, and isolates the new bakery tray 52 and/or its contents in the image in step 108. The at least one computer 12a infers a product type in step 110 using the at least one machine learning model 22a, which in this case is plurality of second bakery products 54b. The analysis may be based at least in part on the second indicia 58b.

The at least one computer 12a increments the tally of bakery trays 52 with products of the identified type (here, second bakery products 54b) in that stack (or on that dolly 80) in step 112. The at least one computer 12a determines if the orders 26 associated with the dollies 80 are all complete. Again, in this example, they are not, so the at least one computer 12a returns to step 102 and receives the next image.

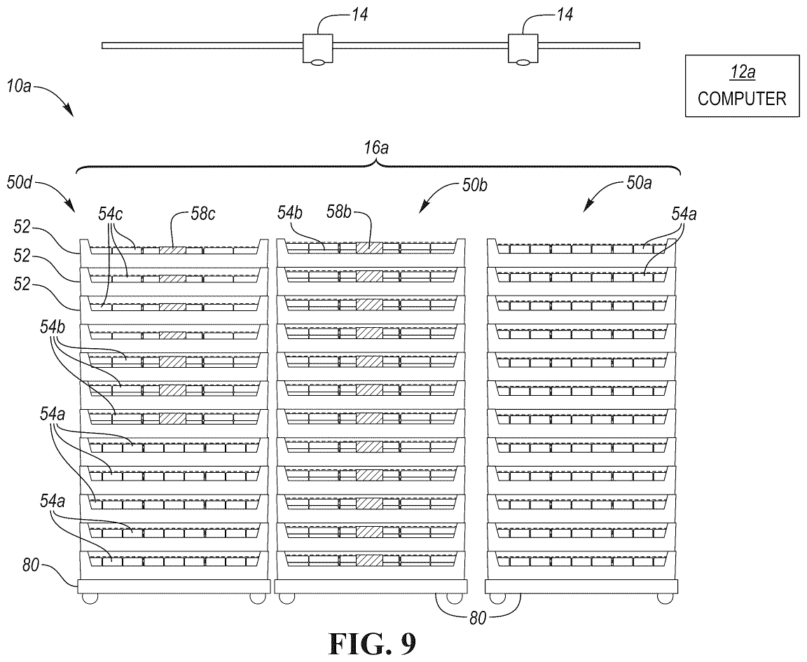

The method 100 of FIG. 10 repeats until all of the orders 26 are complete (at least as far as quantity, as there may still be some errors), as shown in FIG. 9 (again, note that there are six dollies 80 and six stacks 50, but only three are visible in FIG. 9). The at least one computer 12a has tallied five bakery trays 52 having a plurality of first bakery products 54a, three bakery trays 52 having a plurality of second bakery products 54b, and three bakery trays 52 having a plurality of third bakery products 54c, all in one stack 50d on one dolly 80, which would correspond to one order 26 or a portion of an order 26.

The at least one computer 12a has tallied twelve bakery trays 52 having a plurality of second bakery products 54b, all in another stack 50b on another dolly 80, which would correspond to another order 26 or a portion of an order 26. The at least one computer 12a has tallied twelve bakery trays 52 having a plurality of plurality of first bakery products 54a, all in another stack 50a on another dolly 80, which would correspond to another order 26 or a portion of an order 26. Again, in this example, there would be three more stacks 50 (dollies 80), as shown in FIG. 6, that would also be tallied and would each correspond to an order 26 or portion of an order 26.

In step 116, the at least one computer 12a then compares the tallies of bakery products 54 in each stack 50 to the orders 26. In step 118, the at least one computer 12a then indicates confirmation or indicates error, including which order(s) 26, which bakery product types, which stacks 50 and whether there are too many or too few, or whether there are empty bakery trays 52.

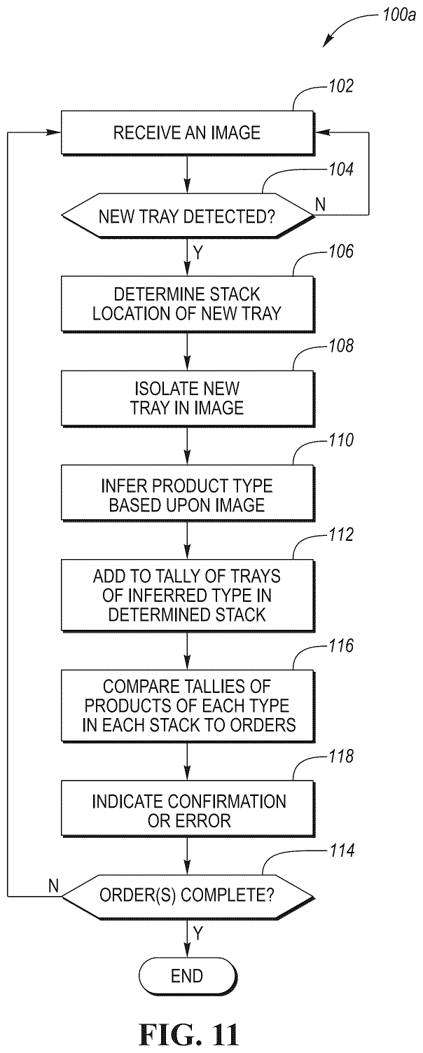

FIG. 11 shows an alternative method 100a which includes the steps of the method 100 of FIG. 10, but some of the steps are in a different sequence. In the method 100a of FIG. 11, step 116, comparing the tallies of products 54 of each type in each stack 50 is performed after every inference in step 110, i.e. as the type of products 54 in each bakery tray 52 is identified. Step 118, indicating a confirmation or an error, is performed after each bakery tray 52 is added to a stack 50.

In any method, the bakery trays 52 may all be identical, in which case the appearance of the bakery trays 52 does not help the at least one computer 12a distinguish the bakery product types.

In another example, at least one of the types of bakery products is exclusively placed in a bakery tray 52 with an appearance that differs in some way (structure, size, color, indicia) from bakery trays 52 containing bakery products of other types. In this example, the different appearances of the bakery trays 52 would assist the at least one computer 12a in distinguishing the type of bakery products in all of the bakery trays 52 (of either type). The at least one machine learning model 22a would be trained on labeled images having the bakery trays 52 with the differences in appearance.

Of course, in a particular distribution center, all of these examples may occur simultaneously, i.e. there may be multiple different types of bakery products that are transported in the same type of bakery tray, while two other types of bakery products are transported in a second type of bakery tray, and while another type of bakery product is transported in the second bakery tray but at a different stacking height. The at least one machine learning model 22a would be trained on labeled images having relevant differences in appearance.

As another option, the at least one machine learning model 22a can be trained with images taken during normal use in the distribution center. Based upon orders 26, the at least one computer 12a instructs the user to pick and place each bakery tray 52 containing a particular bakery product 54 one at a time. The at least one computer 12a then causes the plurality of cameras 14 to image each new bakery tray 52 after it is placed on a stack 50. The at least one computer 12a gathers many (e.g. hundreds) of such images and labels each image with the bakery product type that the at least one computer 12a had instructed to be picked. The at least one computer 12a then analyzes the images with a machine learning model that is not specifically trained on the bakery products in the distribution center, which generates outputs. The at least one computer 12a discards the outputs that are outliers among the images for each bakery product type (i.e. likely picking errors).

After gathering sufficient images and discarding outliers, the at least one machine learning model 22a can be trained with the remaining labeled images. Optionally, in the interim, the at least one computer 12a can generate outputs by using the machine learning model to analyze new images and these outputs can be used to identify a type of bakery product based upon how similar the outputs are to the outputs of the known images.

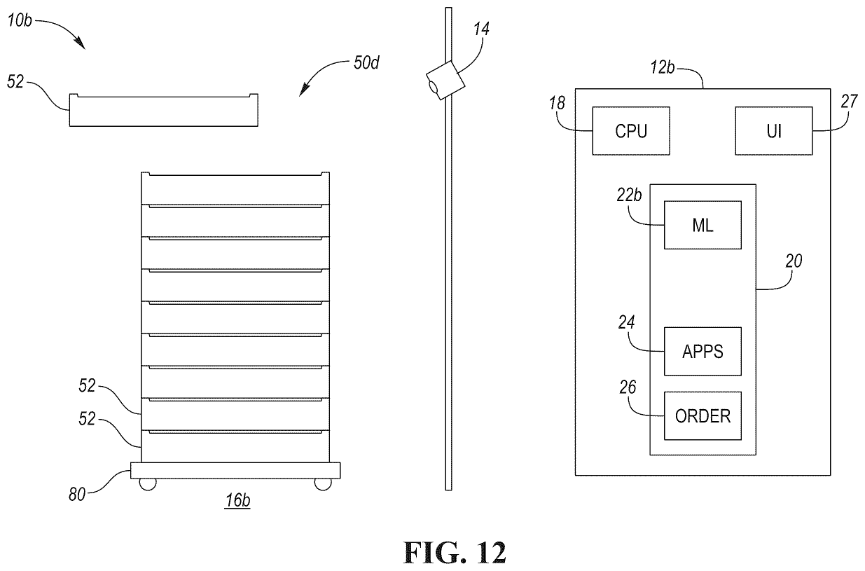

FIG. 12 is a side view of a bakery tray validation system 10b according to another embodiment. The bakery tray validation system 10b includes at least one computer 12b that is identical to the computers 12, 12a of the previous embodiments, but stores instructions that when executed by the at least one processor 18 cause the bakery tray validation system 10b to perform the functions described here. Additionally, in this embodiment, the at least one machine learning model 22b is trained with labeled images that are front/rear views (or as shown, downwardly angled front/rear views) of bakery trays 52 with a plurality of first bakery products 54a, bakery trays 52 with a plurality of second bakery products 54b, bakery trays 52 with a plurality of third bakery products 54c, and empty bakery trays 52. Alternatively, the at least one machine learning model 22b is trained with labeled images that are just front/rear views (or as shown, downwardly angled front/rear views) of the various products 54a, b, c, i.e. without the bakery trays 52. In practice, the at least one machine learning model 22b would likely be trained with images of top views of more than three types of bakery products 54.

The bakery tray validation system 10b includes at least one camera 14 directed toward an imaging area 16b. As shown, the at least one camera 14 could be one camera 14 mounted at or above a height near an expected height of the fourth stack 50d and angled downward to see the entire fourth stack 50d.

In this embodiment, the bakery tray validation system 10b only assists in assembling and validating the fourth stack 50d, i.e. the stack that contains bakery trays 52 containing different types of bakery products (again, each bakery tray 52 only contains bakery products of one type). Often, most of an order 26 will comprise full stacks (e.g. stacks 50a, 50b, 50c that all contain bakery products of a single type) and there will be one stack (e.g. fourth stack 50d) that comprises a mixture of bakery trays 52 containing bakery products of different types. In the embodiment of FIG. 12, only that mixed, fourth stack 50d is validated.

This fourth stack 50d is imaged as it is assembled. The at least one computer 12b instructs the user to assemble the fourth stack 50d based upon the order 26 (again, not including the full stacks—only the stack of mixed bakery product types). The user may retrieve one or two (or more) bakery trays 52 at a time of a single bakery product type and place them on the fourth stack 50d. The plurality of cameras 14 images the one, or two, or three (or more) bakery trays 52 at a time as they are added to the fourth stack 50d using the at least one machine learning model 22b to infer the types of bakery products 54 in each bakery tray 52 (even though it is highly likely that all of the bakery trays 52 added at the same time contain bakery products 54 of the same type). Again, lens correction and keystone correction are performed on each image prior to the separation of the portions of the image corresponding to each bakery tray 52. Then the at least one computer 12b uses the at least one machine learning model 22b to infer the type of bakery products in each of the bakery trays 52.

The at least one computer 12b detects each bakery tray 52 as it is added to the fourth stack 50d (and detects how many bakery trays 52 are being added to the fourth stack 50d). The at least one computer 12b then analyzes the image using the at least one machine learning model 22b to infer which of the types of bakery products is in each bakery tray 52. The at least one computer 12b tallies the types of bakery trays 52 of each type and compares that to the order 26 being picked (or to the pick instructions that were just given). Preferably, the at least one computer 12b compares the tallies (or the instruction) to the order 26 after every bakery tray 52 (or two or more) is added to the fourth stack 50d and either confirms the proper bakery trays 52 have been added or immediately alerts the user if the wrong bakery trays 52 have been added.

Again, in this embodiment, only the mixed, fourth stack 50d is being picked and validated. The other stacks 50, which are completely filled with only one type of bakery product are not validated at the bakery tray validation system 10b. However, optionally, after the fourth stack 50d is completed and confirmed at the bakery tray validation system 10b, the user brings the fourth stack 50d to the imaging area 16 of the bakery tray validation system 10 of the first embodiment to validate the entire order 26, or the user brings the fourth stack 50d to the imaging area 16a of the bakery tray validation system 10a of the second embodiment so that the entire order 26 can be validated. In this manner, the bakery tray validation system 10b helps the user assemble the mixed fourth stack 50d and then validates the entire order at the bakery tray validation system 10 or the bakery tray validation system 10a.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A computer system for validating trays loaded with products comprising:
at least one processor; and
at least one non-transitory computer-readable medium storing:
instructions that, when executed by the at least one processor, cause the computer system to perform the following operations:
a) receiving at least one image of products in at least one tray of a plurality of trays in an imaging area;
b) determining a type of the products in the at least one tray based upon the at least one image; and
c) comparing the type of products in the at least one tray to at least one order.

2. The computer system of claim 1 wherein the at least one non-transitory computer-readable medium further stores at least one machine learning model trained on a plurality of images of bakery products of different types.

3. The computer system of claim 2 wherein the trays are bakery trays and wherein the plurality of images on which the at least one machine learning model is trained are of the bakery products in bakery trays.

4. The computer system of claim 3 wherein plurality of images on which the at least one machine learning model is trained are of the bakery products in bakery trays and wherein the bakery products in each of the plurality of images are partially obscured by a wall.

5. The computer system of claim 3 wherein plurality of images on which the at least one machine learning model is trained are of the bakery products in packages, wherein the packages of the bakery products have different appearances that correspond to different types of bakery products.

6. The computer system of claim 3 wherein plurality of images on which the at least one machine learning model is trained are of the bakery products in the bakery trays, wherein the bakery trays have different appearances that correspond to different types of bakery products.

7. The computer system of claim 2 wherein the plurality of images on which the at least one machine learning model is trained are overhead views of the products in trays.

8. The computer system of claim 7 further including at least one camera positioned over the imaging area.

9. The computer system of claim 7 wherein the trays are bakery trays and wherein the plurality of images on which the at least one machine learning model is trained are of the bakery products in bakery trays.

10. The computer system of claim 9 wherein plurality of images on which the at least one machine learning model is trained are of the bakery products in packages, wherein the packages of the bakery products have different appearances that correspond to different types of bakery products.

11. The computer system of claim 7 wherein the operations further include:
d) receiving an image of the imaging area;
e) based upon the image of the imaging area from operation d), determining whether a new tray is present in the imaging area; and
f) based upon a determination in operation e) that the new tray is present in the imaging area, proceeding to operation a) wherein the at least one tray includes the new tray.

12. A method for validating trays using a computer system having at least one processor, the method including:
a) receiving at least one image of products in a plurality of trays in an imaging area;
b) determining a type of the products in each tray based upon the at least one image; and
c) comparing the types of products in the trays and a number of the trays containing each type of product to at least one order.

13. The method of claim 12 wherein the plurality of trays in the at least one image of products in trays are in a plurality of stacks.

14. The method of claim 13 wherein the at least one image is a front or rear view of the plurality of stacks.

15. The method of claim 13 wherein the at least one image is an overhead view of the plurality of stacks.

16. The method of claim 15 including taking the at least one image with at least one camera mounted overhead the imaging area.

17. The method of claim 16 including detecting a new tray in the plurality of trays in the at least one image.

18. The method of claim 12 wherein step b) includes analyzing the at least one image using a machine learning model trained with a plurality of images of bakery products in bakery trays.

19. The method of claim 18 further including:
d) indicating a confirmation or an error based upon step c).
